(19) United States
(12) Patent Application Publication
(10) Pub. No.: US 2004/0093351 A1
(43) Pub. Date: May 13, 2004

(54) System and method for controlling task assignment and work schedules

(76) Inventors: Chung-I Lee, Tu-Chen (TW); Floye Lin, Shenzhen (CN); David Fan, Shenzhen (CN); Xuechen Lin, Shenzhen (CN); Deyi Xie, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/335,298

(22) Filed: Dec. 30, 2002

(30) Foreign Application Priority Data
Nov. 8, 2002 (TW) 91132848

(51) Int. Cl. G06F 17/00

(52) U.S. Cl. 707/104.1

(57) ABSTRACT

A system for controlling task assignment and work schedules includes a database server (1), an application server (2) for users to access and handle information stored in the database server, and a plurality of distributed client computers (4) connected with the application server by a network (3). The database server is used to store rule information on types of tasks, historical records of tasks, and in-process work of employees of an organization. The application server is used to schedule tasks, assign employees to handle the tasks, monitor handling of the tasks, and integrate results of handling of different tasks by different employees all by using the information stored in the database server. The system provides assignment and scheduling of tasks according to the nature of the tasks and in-process work of employees. Current statuses of tasks are accessible in real time. A related method is also disclosed.

### BACKGROUND OF THE INVENTION

1. Field of the Invention

The present invention relates to systems and methods for controlling task assignment and work schedules, and particularly to a system and method for controlling task assignment and work schedules which can automatically assign and schedule a task according to the nature of the task and in-process work of employees of an organization.

2. Description of Related Art

With the popular usage of electronic information transmission technology, it is now commonplace for enterprises to integrate information using business management systems. For example, in the field of controlling legal tasks that need to be performed by an enterprise, full use of resources and reasonable time arrangements are desired. However, conventional business management systems and methods have certain shortcomings.

A conventional method for controlling task assignment and work schedules is disclosed in U.S. Pat. No. 6,098,070, granted on Aug. 1, 2000 and entitled “Case management for a personal injury plaintiff's law office using a relational database.” This invention discloses an electronic case manager for a personal injury plaintiff's law office, in which plaintiff and defendant level data related to a personal injury incident are collected and organized in an efficient manner. The electronic case manager includes a relational database having a number of tables, and a database management program. Nevertheless, the invention does not provide a method for scheduling particular tasks. Thus work efficiency in the law office is limited.

A system and a method for controlling task assignment and work schedules which can enhance office efficiency and productivity are desired.

### SUMMARY OF THE INVENTION

An objective of the present invention is to provide a system for controlling task assignment and work schedules which automatically schedules and assigns tasks, and monitors handling of the tasks.

Another objective of the present invention is to provide a method for controlling task assignment and work schedules which automatically schedules and assigns tasks, and monitors handling of the tasks.

To achieve the first above-mentioned objective, the present invention provides a system for controlling task assignment and work schedules. A preferred embodiment of the system for controlling task assignment and work schedules comprises a database server, an application server, and a plurality of distributed client computers connected with the application server by a network. The database server is used to store rule information on types of tasks, historical records of tasks, and in-process work of employees of an organization. The application server is used to schedule tasks, assign employees to handle the tasks, monitor handling of the tasks, and integrate results of handling of different tasks by different employees all by using the information stored in the database server. Because the client computers are connected with the application server via the network, the handling of different tasks by all the employees can be effectively coordinated.

To achieve the second above-mentioned objective, the present invention provides a preferred method for controlling task assignment and work schedules. The method provides automatic assignment and scheduling of tasks, and monitoring of handling of the tasks by employees, and comprises the following steps: (a) the application server receiving initial information on a new task; (b) a task monitoring module of the application server scheduling a course to monitor an entire proposed period of handling of the task; (c) analyzing and determining a type of the task according to rule information on types of tasks stored in the database server; (d) the application server connecting with the database server to search for historical records of similar tasks, and scheduling the task; (e) the application server connecting with the database server to search an employee information table for information on in-process work of employees; (f) the system for controlling task assignment and work schedules automatically determining whether a most suitable employee can currently handle the task; (g) if the most suitable employee can currently handle the task, the system for controlling task assignment and work schedules assigning the most suitable employee to handle the task; (h) if the most suitable employee cannot currently handle the task, the system for controlling task assignment and work schedules searching for a next most suitable employee, and determining whether the next most suitable employee can currently handle the task; (i) repeating step (f) if and as necessary until a suitable employee who can currently handle the task is successfully assigned; and (0) the task monitoring module thereafter monitoring and recording actual handling of the task by the employee.

In summary, the system and method of the present invention provide assignment and scheduling of tasks according to the nature of the tasks and in-process work of employees. This enhances efficiency in handling and completion of the tasks.

Other objectives, advantages and novel features of the present invention will be drawn from the following detailed description of the present invention with the attached drawings, in which:

### BRIEF DESCRIPTION OF THE DRAWINGS

FIG. 1 schematically shows infrastructure of a system for controlling task assignment and work schedules in accordance with a preferred embodiment of the present invention;

FIG. 2 is a schematic diagram of software infrastructure of an application server of the system of FIG. 1;

FIG. 3 illustrates an exemplary employee information table according to the present invention; and

FIG. 4 is a flowchart of task control in accordance with the present invention.

### DETAILED DESCRIPTION OF THE INVENTION

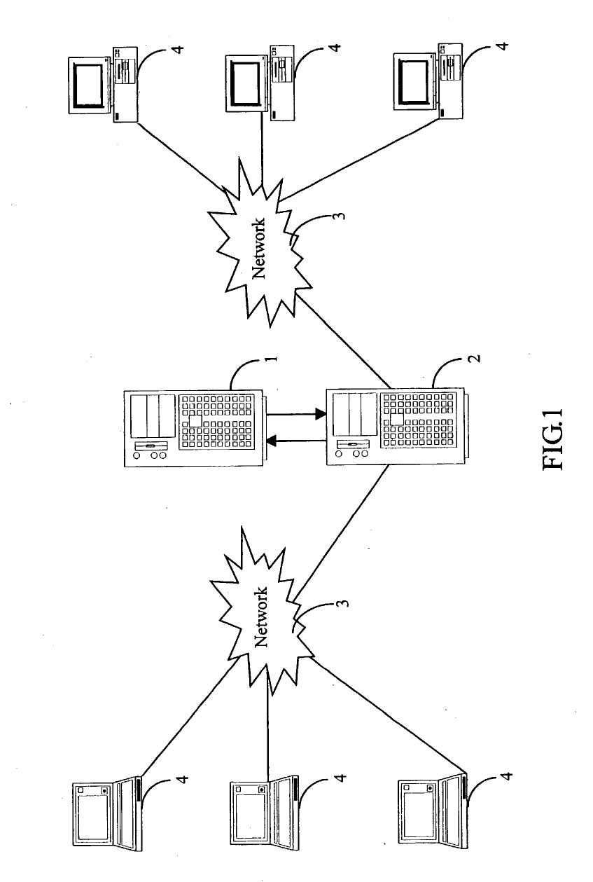

FIG. 1 schematically shows infrastructure of a system for controlling task assignment and work schedules in accordance with a preferred embodiment of the present invention. The system comprises a database server 1, an application server 2, and a plurality of distributed client computers 4 connected with the application server 2 by a network 3. In the preferred embodiment, the network 3 is the Internet 3. The database server 1 is used to store rule information on types of tasks, historical records of tasks, and in-process work of employees of an organization. The application server 2 is used to schedule tasks, assign employees to handle the tasks, monitor handling of the tasks, and integrate results of handling of different tasks by different employees. The application server 2 accomplishes this by using the information stored in the database server 1. Because the client computers 4 are connected with the application server 2 via the Internet 3, the handling of different tasks by all the employees can be effectively coordinated.

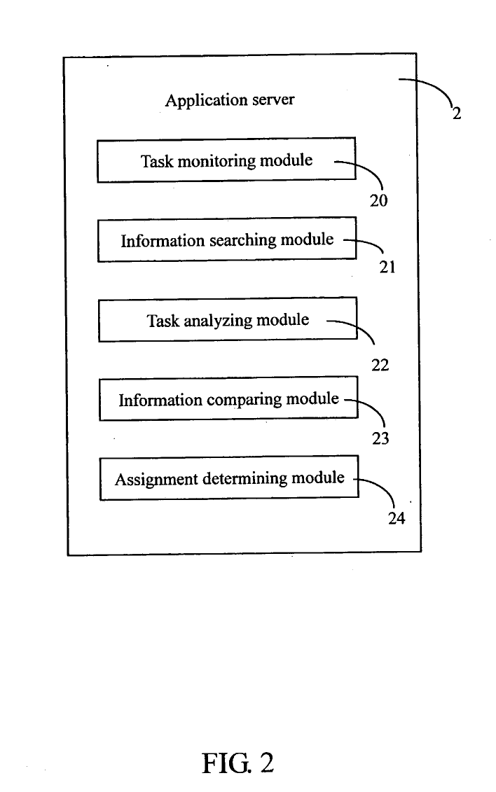

FIG. 2 is a schematic diagram of software infrastructure of the application server 2. The application server 2 comprises a task monitoring module 20, an information searching module 21, a task analyzing module 22, an information comparing module 23, and an assignment determining module 24. The task monitoring module 20 is used to control the scheduling of new tasks received by the application server 2, and to monitor handling of the tasks by employees. In particular, current statuses of tasks being handled are accessible in real time. The information searching module 21 is used to connect with the database server 1 for searching for rule information on types of tasks, historical records of tasks, and information on employees. The task analyzing module 22 is used to analyze the type of a task according to the rule information on types of tasks obtained by the information searching module 21. The information comparing module 23 is used to compare new tasks with historical records of similar tasks, schedule the new tasks, and assign employees to handle the new tasks. The assignment determining module 24 is used to determine whether to go ahead and arrange assigned employees to handle new tasks in accordance with the search results.

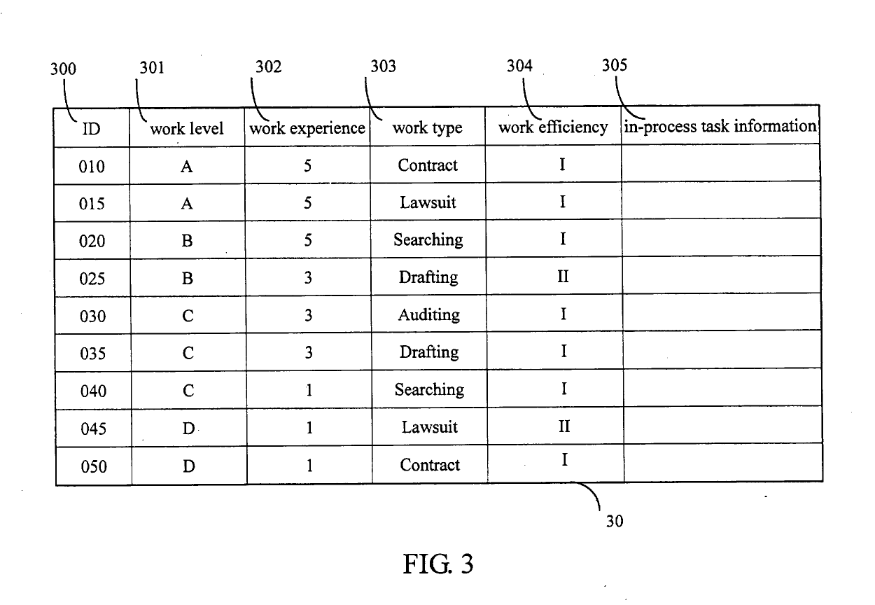

FIG. 3 illustrates an exemplary employee information table 30 according to the present invention. The employee information table 30 is stored in the database server 1. The employee information table 30 contains information on each employee, for reference when the system for controlling task assignment and work schedules assigns employees to conduct a particular new task. The employee information table 30 comprises the following fields: ID 300, work level 301, work experience 302, work type 303, work efficiency 304, and in-process task information 305. ID 300 is used to record an identification number of each employee. Work level 301 is used to record the relative position of each employee in a hierarchy of the organization. Work experience 302 is used to record a period of relevant work experience of each employee. In FIG. 3, details of work experience represent number of years of relevant work experience. Work type 303 is used to record the type of work each employee is best at. In FIG. 3, the types of work recorded are related to legal work, for the purposes of illustration only. Work efficiency 304 is used to record an efficiency of each employee as a reference for determining how well the employee is able to complete a task in time. In-process task information 305 is used to record an amount, type and rate of progress of tasks currently being handled by each employee, as a reference for whether the employee has capacity to handle an extra new task.

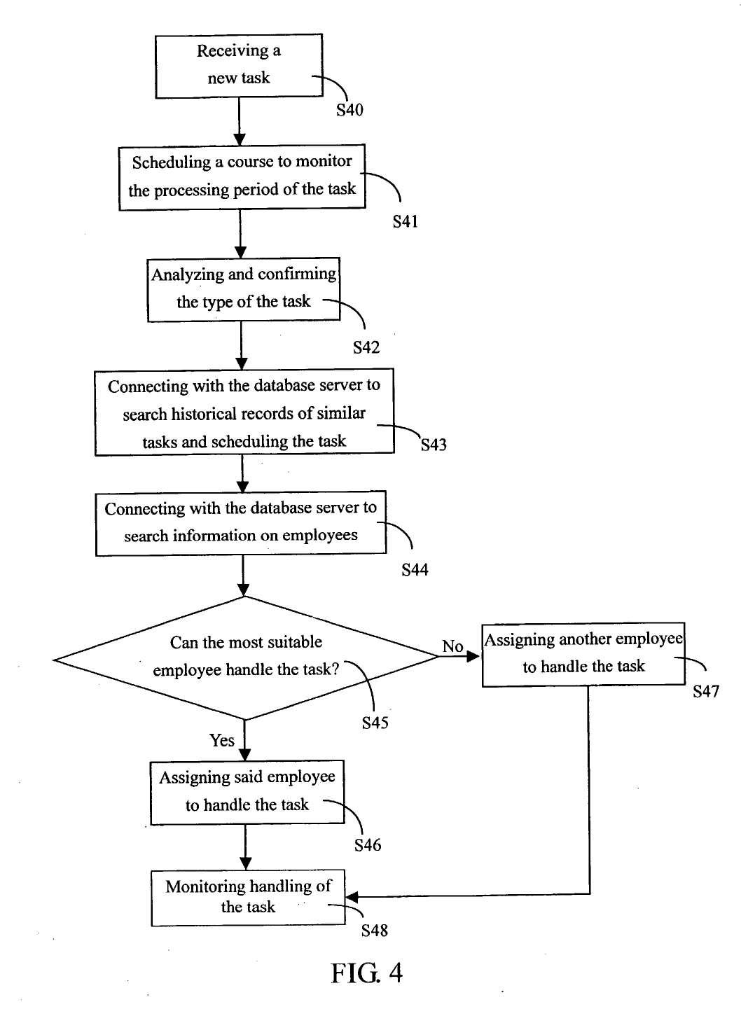

FIG. 4 is a flowchart of task control in accordance with the present invention. Task control includes assignment of tasks, scheduling of work, and monitoring of tasks. Procedures described are implemented in the above-described system for controlling task assignment and work schedules, the system comprising the application server 2 and the plurality of client computers 4. In step S40, the application server 2 receives initial information on a new task. In step S41, the task monitoring module 20 schedules a course to monitor an entire proposed handling period of the task. In step S42, the type of the task is analyzed and determined according to the rule information on types of tasks stored in the database server 1. In step S43, the application server 2 connects with the database server 1 to search for historical records of similar tasks, and to schedule the task accordingly. In step S44, the application server 2 connects with the database server 1 to search the employee information table 30 to find a most suitable employee to handle the task. In step S45, the system for controlling task assignment and work schedules automatically determines whether the most suitable employee can currently handle the task. In step S46, if the most suitable employee can currently handle the task, the system for controlling task assignment and work schedules assigns the most suitable employee to handle the task. In step S47, if the most suitable employee cannot currently handle the task, the system for controlling task assignment and work schedules searches for another employee who is a next most suitable employee, and determines whether the next most suitable employee can currently handle the task. Step S47 is repeated if and as necessary until a suitable employee who can currently handle the task is successfully assigned. If and when an employee for handling the task is assigned, in step S48, the task monitoring module 20 monitors and records actual handling of the task by the employee. Thereafter, a current status of the task is accessible in real time.

In general, the system and method for controlling task assignment and work schedules of the present invention may take forms other than what is described above. While the preferred embodiment for carrying out the invention has been described in detail, those familiar with the art to which the invention relates will recognize various alternative designs and embodiments for practicing the invention. These alternative embodiments are within the scope of the present invention. The scope of the present invention is defined by the claims appended hereto and allowable equivalents thereof.

What is claimed is:

1. A system for controlling task assignment and work schedules, the system comprising a database server, an application server and a plurality of distributed client computers, wherein:
the database server is used to store rule information on types of tasks, historical records of tasks, and in-process work of members of an organization; and
the application server is used to schedule tasks, assign members to handle the tasks, monitor handling of the tasks, and integrate results of handling of different tasks by different members, and the application server comprises:
a task monitoring module, which is used to control scheduling of new tasks received by the application server, and to control handling of the tasks;
an information searching module for searching rule information on types of tasks, historical records of tasks, and information on members; and
an information comparing module, which is used to compare new tasks with historical records of similar tasks, schedule the new tasks, and assign members to handle the new tasks.

2. The system for controlling task assignment and work schedules as described in claim 1, wherein the application server further comprises a task analyzing module for analyzing a type of a task according to the rule information on types of tasks obtained by the information searching module.

3. The system for controlling task assignment and work schedules as described in claim 1, wherein the application server further comprises an assignment determining module for determining whether to go ahead and arrange assigned members to handle a task in accordance with search results.

4. The system for controlling task assignment and work schedules as described in claim 1, wherein the database server further comprises a member information table comprising information on members.

5. A method for controlling task assignment and work schedules, the method comprising the following steps:
(a) receiving initial information on a task, and scheduling a course to monitor handling of the task;
(b) analyzing and determining a type of the task according to rule information on types of tasks, searching historical records of similar tasks, and scheduling the task;
(c) searching information on in-process work of members of an organization; and
(d) automatically selecting a suitable member to handle the task.

6. The method for controlling task assignment and work schedules as described in claim 5, wherein step (d) comprises the step of:
(d1) selecting a suitable member and determining whether the member can currently handle the task.

7. The method for controlling task assignment and work schedules as described in claim 6, wherein step (d) further comprises the step of:
(d2) assigning the member to handle the task if said member can currently handle the task.

8. The method for controlling task assignment and work schedules as described in claim 7, wherein step (d) further comprises the step of:
(d3) selecting another suitable member, and determining whether said another suitable member can currently handle the task if said member cannot currently handle the task.

9. The method for controlling task assignment and work schedules as described in claim 8, wherein step (d) further comprises the step of:
(d4) repeating step (d3) if and as necessary until a suitable member who can currently handle the task is successfully assigned.

10. The method for controlling task assignment and work schedules as described in claim 6, further comprising the following step:
(e) monitoring and recording actual handling of the task by the selected member.

11. A method of controlling task assignment and work schedules, comprising steps of:
receiving initial information on a new task and scheduling a course to monitor handling of said task;
analyzing and categorizing said task according to a rule information of category of tasks;
scheduling said task according to historical records of previous similar tasks;
sourcing work members handling said similar tasks or being qualified to handle the task; and
selecting qualified members in sequence and checking current workload of said qualified members to see whether said task can be assigned to at least one of said qualified members without adjusting workload of said members.
